(19) United States
(12) Patent Application Publication
(10) Pub. No.: US 2026/0206694 A1
(43) Pub. Date: Jul. 23, 2026

(54) HYDRONIC SYSTEM

(71) Applicant: 0865894 B.C. LTD. O/A AGRITECH NORTH, Dryden (CA)

(72) Inventors: Benjamin FEAGIN, JR., Dryden (CA); Nicholas WOOLF, Woodstock (CA)

(21) Appl. No.: 19/455,404

(22) Filed: Jan. 21, 2026

Related U.S. Application Data
(60) Provisional application No. 63/747,946, filed on Jan. 22, 2025.

(51) Int. Cl. A01G 9/24

(52) U.S. Cl. CPC A01G 9/246

(57) ABSTRACT

The system can generally have a duct defining an internal passage, and an access door providing access to the internal passage in a transversal orientation; a heat exchange unit located in the internal passage, the heat exchange unit having a coil defining a liquid conduit and fins in thermal contact with the coil, and being removable from the internal passage via the access door.

### TECHNICAL FIELD

This disclosure relates to air “conditioning” systems, i.e., systems which perform the function(s) of heating, ventilating, cooling and/or de-humidifying the air of an enclosed space.

### BACKGROUND

Remote communities, particularly in northern climates, face many challenges associated with food security. One of these challenges is the availability of fresh food. Indeed, receiving fresh fool from other communities typically entails challenges associated to travel time and conservation, in addition to significant travel costs. One potential solution to address such challenges is to provide remote communities with greenhouses such that fresh food can be grown on-site. However, there are several challenges associated with providing greenhouses in remote communities, and there remained room for improvement.

### SUMMARY

It was found that one of such challenges was that equipment for greenhouses, such as heating, ventilation and air-conditioning (HVAC) systems, may require maintenance by relatively highly trained personnel, potentially even involving certifications, and that such trained personnel may not be readily available at the remote community, such as due to travel considerations, associated costs, or both.

For instance, some HVAC systems may use refrigerant and operate on a thermodynamic cycle involving evaporation of the refrigerant from liquid phase to gaseous phase, compression of the refrigerant in gaseous phase, condensation of the refrigerant from gaseous phase to liquid phase, etc. In such systems, compression is performed with a compressor, and compressors have been known to be prone to failure and maintenance requirements. Moreover, the nature of refrigerants may also impose requirements in terms of training of maintenance personnel.

Another such challenge is that greenhouses sometimes represent very humid environments and equipment located in greenhouses may thus be subjected to significant amounts of mould, mildew, algae, fungus, etc. Such accumulations may form within HVAC systems, namely on exposed surfaces of the heat exchanger, and eventually hinder or impede airflow by clogging the interstices where air is designed to circulate. This can cause malfunction of the HVAC system and a requirement for maintenance.

In some cases, delays in the order or 48 hours without a satisfactorily operating HVAC system may lead to crop destruction, independently of whether the malfunction stems from compressor failure, heat exchanger clogging, or another reason. An occurrence of crop destruction may take in the order of 10 weeks to recover, i.e., to allow crops to grow back to the same growth stage as they were before the occurrence, let alone the costs, work and other inconveniences associated to cleaning up, replanting, etc. This highlights the impact that training requirements may have for maintaining HVAC systems in remote communities.

Some HVAC systems may be simply unsuitable to situations where such issues arise, particularly where such issues are combined.

It was found that such issues could be tackled by an air “conditioning” system designed in a manner that maintenance considerations, namely in remote communities, may represent less of an issue. This may be achieved by designing the system to require less maintenance and/or by designing the system to require less training of the maintenance personnel to perform the maintenance. Using a hydronic liquid may significantly alleviate the maintenance training/certification requirements.

In accordance with a first aspect, using a hydronic liquid (such as water or a water-based solution having some coolant mixed into the water, the latter being potentially useful in colder climates) instead of a refrigerant in the heat exchanger can allow to use simply a pump to circulate the fluid, instead of a compressor. For instance, pumps can be less prone to failure than compressors and thus require less maintenance. Moreover, a hydronic liquid circuit may be easier to open and maintain, such as by being less complicated to maintain in a safe manner or by being less regulated than refrigerant circuits. A greenhouse operator, or greenhouse personnel having a limited amount of training, may be able to open the hydronic liquid circuit to perform maintenance such as changing or maintaining the pump.

In accordance with a second aspect, the system can be provided with one or more heat exchange units which are designed in a manner to be easy to maintain. This can involve, for instance, using one or more heat exchange units which are relatively easy to disconnect from the remainder of the liquid circuit, and to remove from the internal passage of the duct via an access door such as a removable panel forming part of the duct. Moreover, the one or more heat exchange units can be designed in a manner to be pressure-washable, such as by having a fin thickness and an inter-fin spacing adapted to the circulation of pressurized water and/or adapted to reduce the occurrences of clogging.

In accordance with one aspect, there is provided a hydronic system comprising: a duct having an internal passage fluidly connecting an air inlet to an air outlet in a longitudinal orientation, and an access door providing access to the internal passage in a transversal orientation; a heat exchange unit located in the internal passage of the duct section, the heat exchange unit being planar in shape in an orientation transversal to the longitudinal orientation, having fins having a chord extending in the longitudinal orientation and a length extending in the transversal orientation, the fins having a thickness above 0.01 inches and an inter-fin spacing of more than ⅛^{th} of an inch, having a coil in thermally conductive contact with the fins, the coil defining a conduit having a length extending in the planar shape in a back and forth manner, between a coil inlet and a coil outlet, the coil exposed to a flow of air in the duct section between the fins, and being removable from the internal passage via the access door; a hydronic liquid circuit fluidly connecting the conduit, the hydronic liquid circuit being selectively disconnectable from the coil inlet and the coil outlet; and a pump operable to circulate hydronic liquid in the hydronic liquid circuit and in the conduit.

In accordance with another aspect, there is provided a system can generally have a duct defining an internal passage, and an access door providing access to the internal passage in a transversal orientation; a heat exchange unit located in the internal passage, the heat exchange unit having a coil defining a liquid conduit and fins in thermal contact with the coil, and being removable from the internal passage via the access door.

Many further features and combinations thereof concerning the present improvements will appear to those skilled in the art following a reading of the instant disclosure.

### DESCRIPTION OF THE FIGURES

### In the Figures,

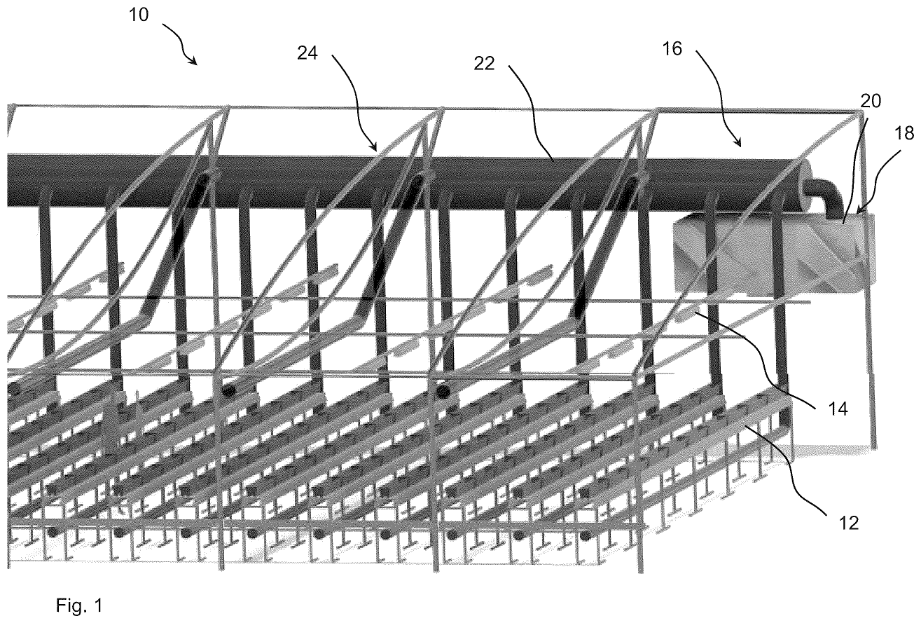

FIG. 1 is a schematic view representing a greenhouse including a hydronic system in accordance with an example embodiment;

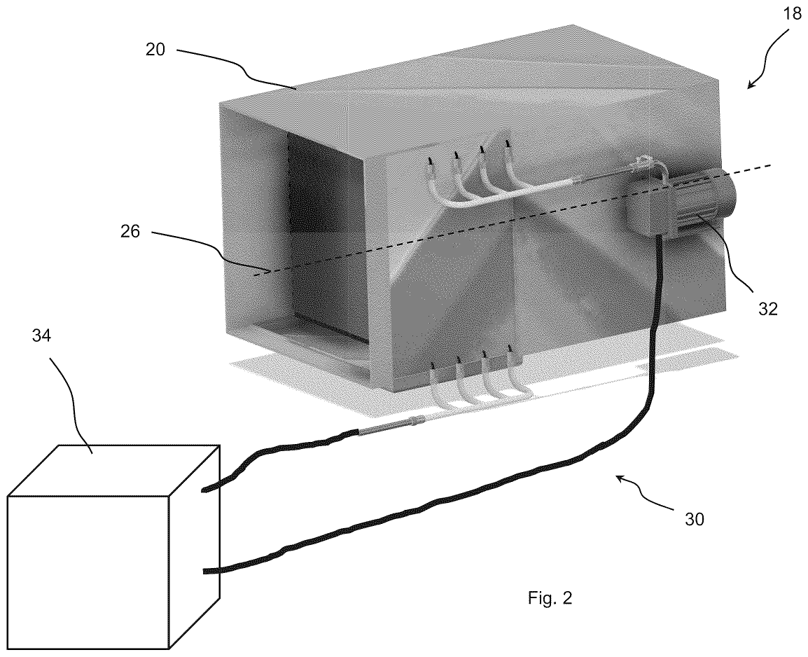

FIG. 2 is a schematic view of the hydronic system of FIG. 1;

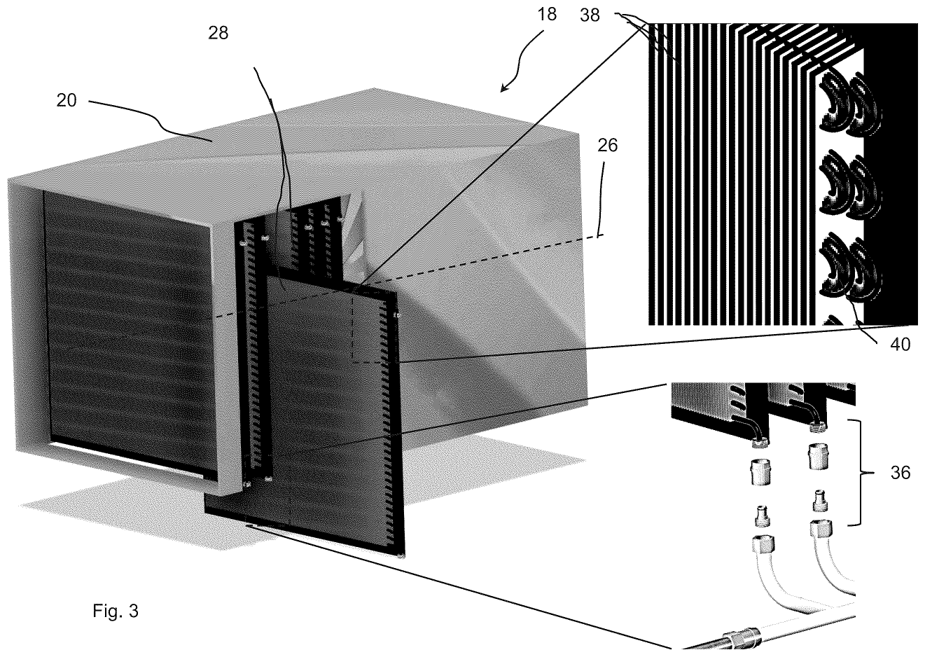

FIG. 3 is an oblique view of the hydronic system of FIG. 1, configured in a manner to show greater detail;

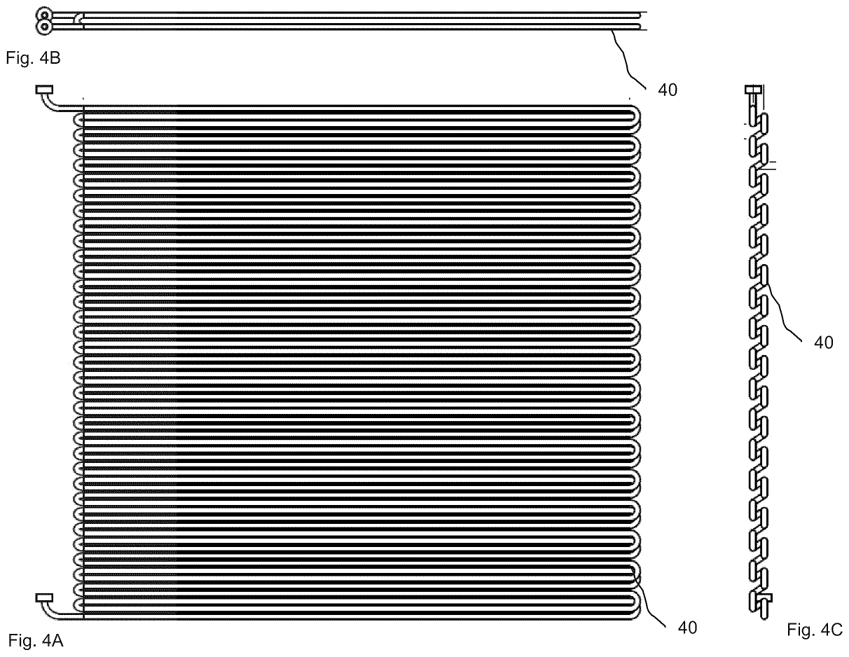

FIGS. 4A, 4B and 4C are front, top and side views of a coil of the hydronic system of FIG. 1;

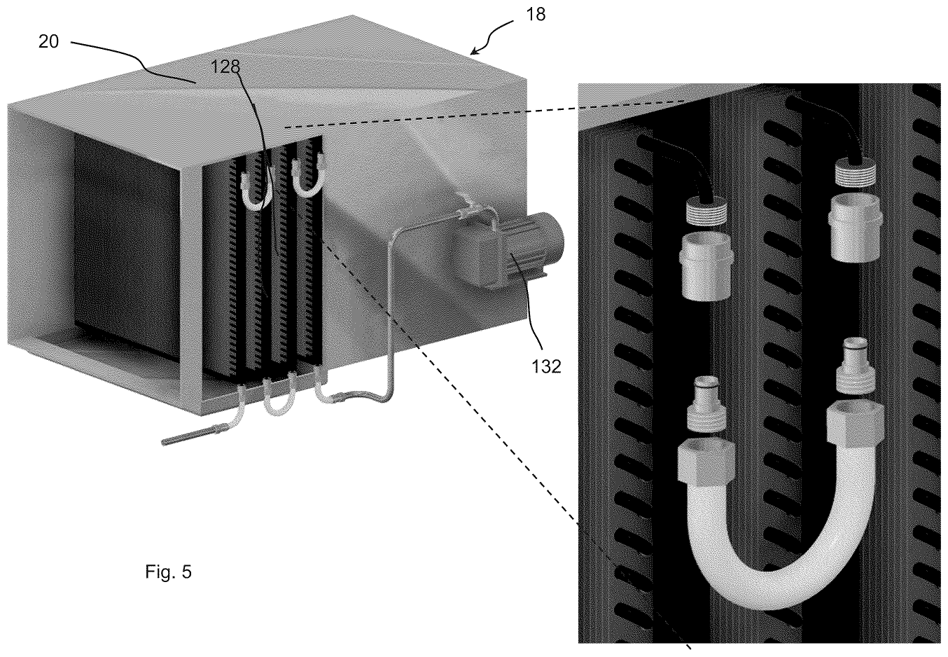

FIG. 5 is an oblique view of a hydronic system in accordance with another example embodiment;

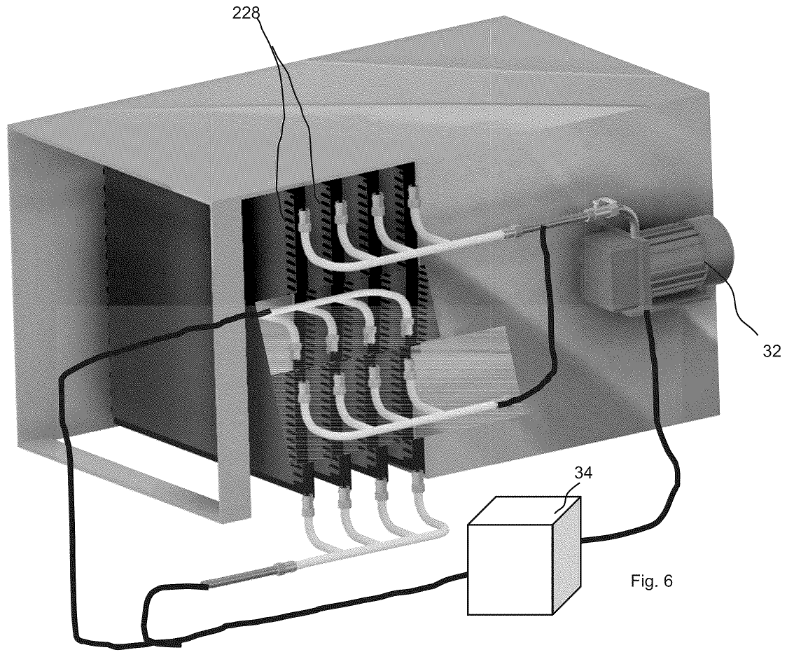

FIG. 6 is an oblique view of a hydronic system in accordance with another example embodiment; and

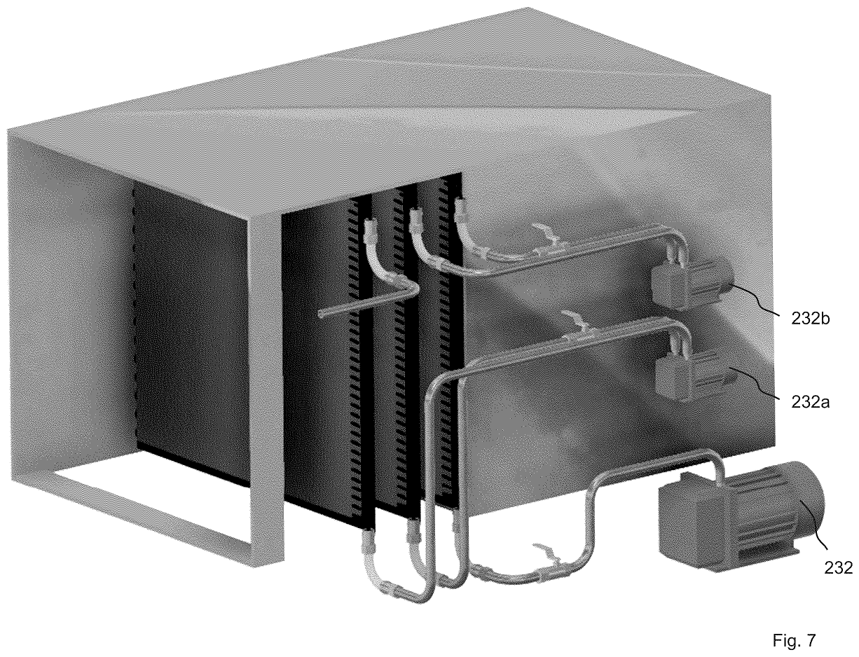

FIG. 7 is an oblique view of a hydronic system in accordance with another example embodiment.

### DETAILED DESCRIPTION

FIG. 1 represents an example greenhouse 10. The greenhouse 10 has a number of crop supports 12 configured for receiving crops, a light system 14 configured to supply artificial light to the crops, an air “conditioning” system 16 including a hydronic system 18 having a duct 20 having an outlet fluidly connected to a network 22 of ventilation conduits. The greenhouse 10 can have a structure 24 which may be fitted with transparent or translucent material such as glass or plastic (not shown). The air conditioning system 16 can be used for heating, ventilating, cooling and/or de-humidifying the air enclosed within the greenhouse 10, for instance, in a manner to provide a suitable environment for the growth of the crops. It will be understood that various configurations of crop growing facilities are possible which may benefit from air conditioning, and that the greenhouse example shown is only provided for illustrative purposes, and not to limit the scope of applicability of the technology described herein.

FIG. 2 presents the example hydronic system 18 in greater detail. The hydronic system 18 includes a duct 20 which defines an internal passage which fluidly connects an air inlet to an air outlet. The orientation of air circulation, extending from the air inlet to the air outlet, will be referred to herein as the longitudinal orientation 26 for ease of reference. The hydronic system 18 further has one or more heat exchange units 28 disposed in the internal passage, as seen in FIG. 3. The one or more heat exchange units 28 are each generally planar in shape in a transversal orientation, transverse to the longitudinal orientation 26. The hydronic system 18 further has a hydronic liquid circuit 30 fluidly connecting the one or more heat exchange units 28, and a pump 32 operable to circulate hydronic liquid in the hydronic liquid circuit and one or more heat exchange units 28. The hydronic liquid can be water, or a mixture of water and coolant. In some embodiments, the hydronic liquid includes more than 45% by weight of water, and less than 45% by weight of a coolant. The addition of coolant may be useful to avoid freezing in some conditions, for instance.

The one or more heat exchange units 28 are configured to favor heat exchange between the air which circulates in the internal passage, and the hydronic liquid which circulates in liquid conduits of the one or more heat exchange units 28. The hydronic system 18 can be used for cooling or heating, for instance. When used for cooling, in certain conditions, considering factors such as dew point, etc., the relative temperature of the hydronic liquid can be controlled in a manner to favor de-humidifying. In this latter mode of operation, water contained in the air can condensate on the exposed surfaces of the one or more heat exchange units 28 and can be collected therefrom. In some cases, a heating coil (not shown) can be integrated to the hydronic system upstream of the one or more heat exchange units 28 in the internal passage, to modify the dew point for the purpose of humidity control, for instance. In some cases, the circulation speed or the temperature of the hydronic liquid in the coils may be controlled for the purpose of humidity control.

One way of controlling the temperature of the hydronic liquid is to circulate the hydronic liquid in one or more cooling subsystems 34. Such cooling subsystems 34 can be considered to form part of the hydronic system 18, and can include a cooling tower, a thermal well, a refrigerator, and/or a chiller such as an absorption chiller and/or an adsorption chiller. There can be more than one cooling subsystem and different ones of the cooling systems may be bypassed selectively based on environmental or operating conditions, for instance.

FIG. 3 presents more detail pertaining to the one or more heat exchange units 28. The heat exchange units may alternately be referred to as cooling assemblies if they are designed specifically for use in cooling rather than heating. In this example, 6 heat exchange units are used and disposed in series in the internal passage of the duct, i.e., parallel to one another and interspaced from one another in the longitudinal orientation 28. Indeed, depending on the embodiment, a different number of heat exchange units 28 may be selected to satisfy a heat exchange and/or target temperature design requirement, and/or to provide different temperatures of hydronic liquid in different ones of the heat exchange units 28. In some cases, a single heat exchange unit 28 may be sufficient.

The one or more heat exchange units 28 can be disconnectable from the hydronic liquid circuit and removable from the internal passage for maintenance, such as replacement or pressure washing. This can be achieved by disconnectable fittings 36, for instance. An access door, such as a removable panel, can be provided as part of the duct to this end. The access door can provide access to the internal passage in the transversal orientation. In the embodiment shown, the connections between the heat exchange units 28 and the remainder of the hydronic liquid circuit are in the form of fittings 36, and all the fittings 36 are disposed on a same side of the duct, the side coinciding with the access door, such that the fittings 36 become exposed when the access door is removed such as shown in FIG. 3. When more than one heat exchange unit 28 is used, it may be convenient for all the heat exchange units 28 to be identical, or to at least roughly have the same specifications, so as to facilitate handling and manipulation.

As shown more clearly in the enlarged window at the top right corner, each heat exchange unit 28 can have fins 38, and a coil 40 defining the conduit for the hydronic liquid. A length of the coil 40 can extend in a back-and-forth manner, in the planar shape, between a coil inlet and a coil outlet. The fins 38 and the coil 40 can be made of a thermally conductive material, such as a metal, and the coil 40 can be in thermally conductive contact with the fins 38, such as via welding or other form of physical contact. The fins 38 can favor heat exchange between the air and the hydronic liquid circulating in the coil 40. The coil 40 can have portions exposed to the flow of air in the duct section between the fins 38.

Heat exchange units 28 can be relatively delicate, and the fins 38 may be subject to bending or breaking, which may make them ill-adapted to pressure washing. Indeed, HVAC heat exchanger fins can have between 0.006 and 0.01 inch in thickness, and a spacing of between 8 and 16 fins per inch, which may be ill adapted to pressure washing. However, in some cases, more rugged fins, such as fins having between 0.01 and 0.04 inches in thickness and spaced by 8 fins per inch or less, may be suitable to achieve a targeted temperature or heat exchange design requirement, while being compatible with pressure washing. The effect of the use of such fins instead of a greater number of finer fins on heat transfer capacity may be compensated, to a certain extent, by using larger heat exchange units 28, or a greater number of heat exchange units 28 in series in the air flow, which are two example ways of increasing the heat exchange surface of contact.

In the example shown, the hydronic system 18 is configured in a manner for the heat exchange units 28 to be easy to remove from the internal passage. More specifically, connectors, such as quick connect fittings 36 for instance, may be used between the coil inlet(s) and the remainder of the hydronic liquid circuit 30, and between the coil outlet(s) and the remainder of the hydronic liquid circuit 30. Once the one or more heat exchange units 28 have been disconnected from the remainder of the hydronic liquid circuit 30, they may be individually, or collectively, removable from the internal passage through the access door (e.g. by removing one or more wall panel of the duct).

In some cases, it may be desired for the heat exchange units 28 to be removable manually by a person which has climbed a ladder, for instance, in which case it can be preferred for the one or more heat exchange units 28 to have less than 50 pounds. In other cases, it can be desired to perform maintenance on the heat exchange units 28 using scissor lift or other form of mechanical assistance. In such cases, it may be acceptable for heat exchange units to have more than 50 pounds, such as 70 pounds for instance, or for heat exchange units to be removable collectively from the internal passage, rather than individually.

FIG. 4 presents one possible example of a coil 40 configuration. In this example, the coil 40 goes back and forth in the transversally-oriented plane of the heat exchange unit in two layers, which was found suitable to increase heat exchange capacity in some embodiments. In other embodiments, the coil may go back-and-forth in a single layer, for instance.

Many variations are possible from one embodiment to another. For instance, it was exposed above that more than one heat exchange unit 28 may be used in series in the internal passage. In such cases, in some examples, a single pump may be used circulate the hydronic liquid in the different heat exchange units 28. This may involve circulating the hydronic liquid in parallel or in series. By abundance of caution, to maximise clarity, parallel or series connection of coils in the one or more heat exchange units 28 are not to be confused with parallel or series arrangement of heat exchange units 28 or coils 40 in the internal passage. In the case of the former, parallel or series is used relative to the flow of hydronic fluid, and in the case of the latter, parallel or series is used relative to the flow of air.

FIGS. 2 and 3 provide an example where a single pump 32 is used to circulate the hydronic liquid in the plurality of heat exchange units 28 in parallel. The hydronic liquid circuit has a first manifold between an outlet of the pump 32 and the coil inlets of the different heat exchange units 28, and a second manifold between the coil outlets of the different heat exchange units 28 and the inlet of the pump 32. Depending on the embodiment, the manifold(s) may be distinct from the heat exchange units 28 and disconnectable therefrom or may be integrated to the heat exchange units 28 and removable from the internal passage therewith, to name two examples.

FIG. 5 presents another example where a single pump 132 is used to circulate the hydronic liquid in the plurality of heat exchange units 128 in series. More specifically, an inlet of the pump 132 can be connected to the coil inlet of a first one of the heat exchange units 128, the outlet of the first heat exchange unit 128 can be connected to an inlet of the second heat exchange unit 128, and so forth until the outlet of the last heat exchange unit 128 can be connected back to the inlet of the pump 132.

In some embodiments, it may be desired to use more than one heat exchange unit within a single transversal plane, such as by having two, or four heat exchange units arranged side-by-side and/or above one another, each spanning only a portion of the transversal width and/or height of the internal passage. In such configurations as well, a manifold may be used to distribute hydronic liquid to the inlets of all the heat exchange units, and/or to retrieve the hydronic liquid from the outlets of all the heat exchange units. In such an arrangement, the two or more heat exchange units may have distinct coils and distinct sets of fins or may have distinct coils and share a same set of fins, to name some examples.

FIG. 6 presents one such example where individual ones of the heat exchange units 228 have a top coil and a bottom coil, each one having its corresponding inlet and outlet, and being connected to a corresponding pair of manifolds.

In some embodiments, it may also be desired to use more than one pump to supply different ones of the coils, and/or to use booster, or step-up pumps between individual coils in a series configuration.

FIG. 7 presents one example configuration where step-up pumps 232a, 232b are used, in addition to primary pump 232, and more specifically disposed between coils in a series configuration of the hydronic liquid circulation.

As can be understood, the examples described above and illustrated are intended to be exemplary only. The scope is indicated by the appended claims.

What is claimed is:

1. A hydronic system comprising:
a duct defining an internal passage fluidly connecting an air inlet to an air outlet in a longitudinal orientation, the duct having an access door providing access to the internal passage in a transversal orientation;
a heat exchange unit located in the internal passage, the heat exchange unit
having fins with a chord extending in the longitudinal orientation and a length extending in the transversal orientation, the fins having a thickness above 0.01 inches and an inter-fin spacing of more than ⅛^{th} of an inch,
having a coil in thermally conductive contact with the fins, the coil defining a conduit having a length extending in a back-and-forth manner, between a coil inlet and a coil outlet, and
being removable from the internal passage via the access door;
a hydronic liquid circuit fluidly connecting the conduit, and being selectively disconnectable from the coil; and
a pump operable to circulate hydronic liquid in the hydronic liquid circuit and in the conduit.

2. The hydronic system of claim 1 wherein the hydronic liquid circuit further comprises a cooling subsystem configured for extracting heat from the hydronic liquid.

3. The hydronic system of claim 1 or 2 further comprising connexion fittings between the coil inlet and the hydronic liquid circuit, and between the coil outlet and the hydronic liquid circuit.

4. The hydronic system of any one of claims 1 to 3 wherein the hydronic liquid includes more than 45% by weight of water and less than 45% by weight of a coolant.

5. The hydronic system of any one of claims 1 to 4 wherein the heat exchange unit weighs less than 70 pounds.

6. The hydronic system of claim 5 wherein the heat exchange unit weighs less than 50 pounds.

7. The hydronic system of any one of claims 1 to 6 wherein the hydronic system includes more than one of the heat exchange unit.

8. The hydronic system of claim 7 wherein the more than one heat exchange units include at least two heat exchange units disposed parallel to one another and longitudinally interspaced from one another in the internal passage.

9. The hydronic system of claim 8 wherein the at least two heat exchange units are removable from the internal passage individually from one another.

10. The hydronic system of claim 7 wherein the one or more heat exchange units includes at least two heat exchange units disposed transversally adjacent to one another and transversally spanning the internal conduit.

11. The hydronic system of claim 10 wherein the at least two heat exchange units share said fins.

12. The hydronic system of any one of claims 1 to 11 wherein the fins have a thickness of 0.04 inches or less.

13. The hydronic system of any one of claims 1 to 12 wherein the fins have an inter-fin spacing of less than ¼ of an inch.

14. The hydronic system of any one of claims 1 to 13 further comprising a heating coil disposed upstream of the heat exchange unit in the internal passage.

15. A greenhouse having an air conditioning system including a duct, one or more cooling assemblies extending transversally inside the duct, each one of the cooling assemblies being generally planar in shape, having a coil going back and forth along a width and a height of the planar shape, between an inlet and an outlet, and several fins oriented in a flow direction of the duct, the fins in thermally-conductive contact with the coil, the fins having a thickness above 0.01 inches and an inter-fin spacing of more than ⅛^{th} of an inch.

16. A greenhouse having an air conditioning system including a duct, one or more cooling assemblies extending transversally inside the duct, each one of the cooling assemblies being generally planar in shape, having a coil going back and forth along a width and a height of the planar shape, between an inlet and an outlet, and several fins oriented in a flow direction of the duct, the fins in thermally-conductive contact with the coil, a hydronic liquid circuit fluidly connecting the coil, and being selectively disconnectable from the coil; and a pump operable to circulate hydronic liquid in the hydronic liquid circuit and in the coil.

17. The greenhouse of claim 16 wherein the fins have a thickness above 0.01 inches and an inter-fin spacing of more than ⅛^{th} of an inch.
